(19) United States
(12) Patent Application Publication
(10) Pub. No.: US 2025/0090996 A1
(43) Pub. Date: Mar. 20, 2025

(54) ACID GAS REMOVAL METHOD, ACID GAS ABSORBENT, AND ACID GAS REMOVAL APPARATUS

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Akiko SUZUKI, Ota (JP); Yoshihiko NAKANO, Yokohama (JP); Reiko YOSHIMURA, Kawasaki (JP); Hitomi SAITO, Taito (JP); Asato KONDO, Yokohama (JP); Shinji MURAI, Sagamihara (JP); Noriko TAKADA, Meguro (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/603,539

(22) Filed: Mar. 13, 2024

(30) Foreign Application Priority Data
Sep. 20, 2023 (JP) 2023-151930

(51) Int. Cl. B01D 53/14

(52) U.S. Cl. CPC B01D 53/1475; B01D 53/1425; B01D 53/1493; B01D 2252/20426; B01D 2252/20431

(57) ABSTRACT

The present embodiment provides an acid gas absorbent producing less waste and having a low environmental load, a method for removing an acid gas using the acid gas absorbent, and an acid gas removal apparatus. In the acid gas absorbent according to the present embodiment, a solubility in water of a salt formed from a liquid amine compound and the acid gas is higher than a solubility in water of the liquid amine compound. Further, the amine compound and water are separated into two phases before absorption of the acid gas or after desorption thereof, and, in this state, the acid gas absorbent is easily separated from water-soluble impurities and purified.

### CROSS REFERENCE TO RELATED APPLICATIONS

This application is based upon and claims the benefit of priority from the prior Japanese Patent Application No. 2023-151930, filed on Sep. 20, 2023, the entire contents of which are incorporated herein by reference.

### FIELD

Embodiments of the present invention relate to an acid gas removal method, an acid gas absorbent, and an acid gas removal apparatus.

### BACKGROUND

In recent years, a greenhouse effect caused by an increase in carbon dioxide (CO₂) concentration has been pointed out as one factor for global warming phenomena, and international measures for protecting the environment on a global scale are urgently needed. CO₂ is generated mainly by industrial activities, and there is a growing momentum to suppress emission of CO₂ to the environment. In particular, reduction in CO₂ emissions from coal-fired power plants and factories is urgently needed. In addition to CO₂, it has also been attempted to reduce emissions of acid gases such as hydrogen sulfide (H₂S).

Therefore, as methods for reducing emissions of acid gases such as CO₂, reduction in emissions by increasing the efficiency of thermal power plants and the like, and recovery of carbon dioxide by a chemical absorbent have attracted great attention. As a specific absorbent, absorption by an amine compound has been studied for a long time. However, in steps of absorbing and releasing CO₂ by the chemical absorbent, it is known that the absorbent is sometimes heated in order to regenerate the chemical absorbent, whereby the amine compound contained in the absorbent is oxidized and deteriorated. In addition, it is known that an exhaust gas contains not only carbon dioxide but also SOx, NOx, and the like, and also that these compounds also accelerate deterioration in amine compound and form a thermally stable salt with an amine compound (Patent Document 1). The oxidization of and deterioration in an amine compound or the formation of a thermally stable salt results in a decrease in acid gas absorption performance. Therefore, it is necessary to maintain the acid gas absorption performance by a regeneration treatment by distillation or electrodialysis of the amine compound or complete replacement of an absorption liquid. When the absorption liquid is completely replaced, a large amount of waste of the amine compound is produced, and thus it is also necessary to devise to reduce a load on the environment.

### BRIEF DESCRIPTION OF THE DRAWINGS

FIG. 1 is a schematic diagram of an acid gas removal apparatus according to an embodiment.

### DETAILED DESCRIPTION

An acid gas removal method according to the present embodiment is an acid gas removal method for removing an acid gas from a gas to be treated containing the acid gas, the method including:
a first step of bringing the gas to be treated into contact with an acid gas absorbent to absorb the acid gas; and
a second step of releasing a part of the acid gas from the acid gas absorbent that has absorbed the acid gas in the first step to regenerate the acid gas absorbent, wherein
the acid gas absorbent is a mixture containing a liquid amine compound having a secondary amine structure and water, and
an amount of a salt to be dissolved in water is larger than an amount of the liquid amine compound to be dissolved in water, the salt being formed from the liquid amine compound and the acid gas.

An acid gas remover according to the present embodiment is an acid gas remover containing a mixture of a liquid amine compound having a secondary amine structure and water, wherein
an amount of a salt to be dissolved in water is larger than an amount of the liquid amine compound to be dissolved in water, the salt being formed from the liquid amine compound and the acid gas.

An acid gas removal apparatus according to the present embodiment is an acid gas removal apparatus including:
an absorber that removes an acid gas from a gas to be treated containing the acid gas by causing the acid gas absorbent to absorb the acid gas by contact between the gas to be treated and the acid gas absorbent; and
a regenerator that desorbs the acid gas from the acid gas absorbent that has absorbed the acid gas to regenerate the acid gas absorbent.

Embodiments will now be explained with reference to the accompanying drawings.

### <Acid Gas Absorbent>

In the following embodiments, a case where the acid gas is carbon dioxide will be mainly described as an example. However, the acid gas absorbent according to an embodiment can provide the same effect also on other acid gases such as hydrogen sulfide. The acid gas absorbent according to the embodiment is suitable for absorption of oxidized gases such as carbon dioxide and hydrogen sulfide. Among them, it is particularly suitable for absorption of carbon dioxide, and is suitable for removal and recovery of carbon dioxide from a gas to be treated such as a factory exhaust gas.

An acid gas absorbent according to the embodiment contains an amine compound and water, as main agents for absorbing an acid gas. The amine compound used here is a liquid amine compound having a secondary amine structure. An acid gas remover contains a mixture of the liquid amine compound and water, and an amount of a salt to be dissolved in water is larger than an amount of the liquid amine compound itself to be dissolved in water, the salt being formed from the liquid amine compound and the acid gas. Here, the liquid amine compound is an amine compound that is liquid at 25° C. under atmospheric pressure. An amount of the liquid amine compound to be dissolved at room temperature is generally small, and, for example, an amount of the liquid amine compound to be dissolved in water at 25° C. is 50,000 mg/L or less. Upon contact of the liquid amine compound with the acid gas, a salt is formed, and is ionized when water coexists, to increase the dissolved amount. The amount of such a salt to be dissolved is, for example, 2 times or more, preferably 5 times or more, and more preferably 10 times or more the amount of the liquid amine to be dissolved as a base at 25° C. In the present embodiment, the dissolved amount (mg/L) is a mass (mg) of the liquid amine based on a total volume (L) of water and the liquid amine compound.

When the liquid amine compound contained in the acid gas absorbent according to the embodiment is brought into contact with the acid gas, the amount thereof to be dissolved in water increases. However, the liquid amine compound is incompatible with water before contact with the acid gas. Therefore, the acid gas absorbent is in a state in which an organic phase (layer containing the liquid amine compound) and an aqueous phase are separated from each other, typically in a two-phase state. When the acid gas absorbent is brought into contact with the acid gas, the liquid amine compound is charged and easily dissolved in water, so that the two layers are compatible with each other, and the acid gas absorbent typically has one phase. The acid gas absorbent after absorbing the acid gas can release the acid gas by heating, pressure reduction, or the like, and has a property of forming two phases of the liquid amine compound and water again after the release. Therefore, the acid gas absorbent according to the embodiment can be regenerated by a treatment such as heating or pressure reduction. A general acid gas absorbent may also be regenerated by heating or the like. In such a case, the heating temperature needs to be 120° C. or higher. On the other hand, when the acid gas absorbent according to the embodiment is regenerated by heating, it can be regenerated at a heating temperature of, for example, 80° C. or lower, preferably 70° C. or lower.

The acid gas absorbent is generally repeatedly used for removal and recovery of an acid gas from a gas to be treated, and is gradually deteriorated by impurities such as water-soluble amine degradation products, metal ions, thermally stable salts, and organic acids. In a case where the acid gas absorbent according to the embodiment is contaminated with impurities, when the acid gas is released from the acid gas absorbent and the acid gas absorbent is separated into the amine compound phase and the aqueous phase, the contaminants are dissolved in the aqueous phase, so that the liquid amine compound and the contaminants can be separated from each other. The acid gas absorbent can be regenerated by newly adding water to the liquid amine compound after separation, and, due to a low water content rate even at the time of purifying the liquid amine compound, the energy required for purifying the liquid amine compound can be reduced, which is advantageous in terms of energy.

Here, in the present embodiment, the “state in which the organic phase and the aqueous phase are phase-separated” means that, for example, a mixture of water and a liquid amine has a relationship in which a state in which the organic phase and the aqueous phase are phase-separated, in other words, a boundary between the organic phase and the aqueous phase can be visually confirmed. Here, in the present embodiment, the organic phase is a phase containing the liquid amine compound as a main component in a state of being phase-separated, and is also a phase containing a high concentration of the liquid amine compound in a state of being separated from the acid gas. The aqueous phase is a phase containing water as a main component in a state of being phase-separated. At a high carbon dioxide concentration, the acid gas absorbent has an increased amount of the liquid amine compound to be dissolved in water, and the liquid amine compound is dissolved in an aqueous solution. In the acid gas absorbent, the organic phase and the aqueous phase are not phase-separated in this state (the acid gas absorbent has one phase). At a low acid gas concentration, the acid gas absorbent is decreased in solubility of the liquid amine compound in water, and is phase-separated into an aqueous phase and an organic phase containing a high concentration of the liquid amine compound. When the acid gas absorbent is phase-separated, the organic phase and the aqueous phase typically form complete two phases. However, in the present embodiment, even when it is not completely phase-separated, the organic phase and the aqueous phase are referred to as “two phases” in a case where a boundary between the phases can be confirmed.

The liquid amine compound used in the embodiment has a secondary amine structure, and, as described above, the amount of the liquid amine compound to be dissolved in water changes by contact with an acid gas.

When the liquid amine compound used in the present embodiment has secondary amine and tertiary amine structures, the secondary amine structure preferably exists more than the tertiary amine structure. The liquid amine compound of the present embodiment preferably contains one or more secondary amine structures, and one or less tertiary amine structures.

Such a liquid amine compound is preferably represented by the following formula (a) or (b):

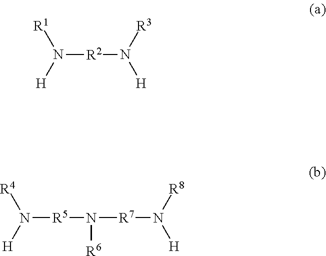

wherein:
R¹, R³, R⁴, and R⁸ are each independently a linear alkyl group, a branched alkyl group, a cyclic alkyl group, a heterocyclic aliphatic group containing oxygen or sulfur, a substituted or unsubstituted aliphatic group composed of three elements of carbon, nitrogen, and hydrogen atoms, or a substituted or unsubstituted aromatic group,
R², R⁵, and R⁷ are each independently a C1 to C7 linear alkylene chain or a C3 to C7 branched alkylene chain, and
R⁶ is a linear alkyl group, a branched alkyl group, a substituted or unsubstituted aliphatic group composed of three elements of carbon, nitrogen and hydrogen atoms, a substituted or unsubstituted aromatic group, or hydrogen.

More preferably,
R¹, R³, R⁴, and R⁸ are each independently a linear or branched C3 to C6 alkyl group,
R², R⁵, and R⁷ are each independently a C2 to C4 linear alkylene chain or a C3 to C4 branched alkylene chain, and
R⁶ is hydrogen or a linear or branched C1 to C3 alkyl group.
R¹ and R³ are more preferably the same. Also, R⁴ and R⁸ are more preferably the same.
R⁵ and R⁷ are more preferably the same.

The liquid amine compound represented by Formula (a) more preferably has a symmetrical structure about R². The liquid amine compound represented by Formula (b) more preferably has a symmetrical structure about NR⁶.

From the viewpoint of responsiveness of phase separation in response to carbon dioxide, the number of carbon atoms (C/N) relative to the number of nitrogen atoms contained in the liquid amine compound represented by Formula (a) and/or Formula (b) is preferably 4 or more and 12 or less, more preferably 4 or more and 10 or less, and even more preferably 5 or more and 8 or less. A small number of carbon atoms relative to the number of nitrogen atoms tends to result in easy dissolution of the liquid amine compound in water and difficulty in phase separation, and thus caution is required. In addition, a large number of carbon atoms relative to the number of nitrogen atoms may result in a high viscosity and difficulty in handling, and thus caution is required. From the above viewpoints, the number of carbon atoms (C/N) relative to the number of nitrogen atoms contained in the secondary amine compound represented by Formula (a) is more preferably 5 or more and 7 or less, and even more preferably more than 5 and 7 or less.

R⁶ is more preferably a methyl group or hydrogen.

R² is more preferably a linear propylene chain. Also, R⁶ is more preferably a linear propylene chain. Also, R⁷ is more preferably a linear propylene chain.

Specific examples of such a liquid amine compound include the following compounds.
Et₂CH—NH(CH₂)₂NH—CHEt₂
Et₂CH—NH(CH₂)₃NH—CHEt₂
Et₂CH—NH(CH₂)₄NH—CHEt₂
Et₂CH—NH(CH₂)₅NH—CHEt₂
Et₂CH—NH(CH₂)₆NH—CHEt₂
Cyclopentyl-NH(CH₂)₂NH-Cyclopentyl
Cyclopentyl-NH(CH₂)₃NH-Cyclopentyl
Cyclohexyl-NH(CH₂)₃NH-Cyclohexyl
Me₃C≡NH(CH₂)₃NH—CMe₃
Me₂CHCH₂MeCH—NH(CH₂)₃NH—CHMeCH₂CHMe₂
Me₂CHCH₂MeCH—NH(CH₂)₄NH—CHMeCH₂CHMe₂
Me₂CHCH₂MeCH—NH(CH₂)₂NH—CHMeCH₂CHMe₂
EtMeCH—NH(CH₂)₂NH—CHMeCH₂CHMe
Cyclopentyl-NH(CH₂)₂NH—CHEt₂
Cyclohexyl-NH(CH₂)₃NH—CHEtMe
EtMeCH—NH(CH₂)₂NH—CHMeCH₂CHMe₂
(Me₂CH)₂CH—NH(CH₂)₂NH—CHMe₂
EtMeCH—NH(CH₂)₂NH—CH(CHMe₂)₂
Me₂CHCH₂MeCH—NH(CH₂)₂NH(CH₂)₂NH—CHMeCH₂CHMe₂
Me₂CHCH₂MeCH—NH(CH₂)₃NH(CH₂)₃NH—CHMeCH₂CHMe₂
Me₂CHCH₂MeCH—NH(CH₂)₄NH(CH₂)₄NH—CHMeCH₂CHMe₂
Et₂CH—NH(CH₂)₃NH(CH₂)₃NH—CHEt₂
Et₂CH—NH(CH₂)₂NMe(CH₂)₂NH—CHEt₂
Et₂CH—NH(CH₂)₃NMe(CH₂)₃NH—CHEt₂
Et₂CH—NH(CH₂)₄NMe(CH₂)₄NH—CHEt₂
EtMeCH—NH(CH₂)₃NMe(CH₂)₃NH—CHEtMe
(Me₂CH)₂CH—NH(CH₂)₃NMe(CH₂)₃NH—CH(CHMe₂)₂
Me₂CHCH₂MeCH—NH(CH₂)₂NMe(CH₂)₂NH—CHMeCH₂CHMe₂
Me₂CHCH₂MeCH—NH(CH₂)₃NMe(CH₂)₃NH—CHMeCH₂CHMe₂
Me₂CHCH₂MeCH—NH(CH₂)₄NMe(CH₂)₄NH—CHMeCH₂CHMe₂
Me₃C≡NH(CH₂)₂N(CMe₃)(CH₂)₂NH—CMe₃
Me₃C≡NH(CH₂)₃NCMe(CH₂)₃NH—CMe₃
Et₂CH—NH(CH₂)₃NEt(CH₂)₃NH—CHEt₂
Et₂CH—NH(CH₂)₃N(CHMe₂)(CH₂)₃NH—CHEt₂
Et₂CH—NH(CH₂)₂NH(CH₂)₂NH—CHEt₂
Et₂CH—NH(CH₂)₄NH(CH₂)₄NH—CHEt₂
Et₂CH—NH(CH₂)₃NH(CH₂)₃NH—CHMeCH₂CHMe₂
EtMeCH—NH(CH₂)₃NH(CH₂)₃NH—CHMeCH₂CHMe₂
EtMeCH—NH(CH₂)₃NMe(CH₂)₃NH—CHMeCH₂CHMe₂
Et₂CH—NH(CH₂)₂NH(CH₂)₂NH—CHMeCH₂CHMe₂
EtMeCH—NH(CH₂)₂NH(CH₂)₂NH—CHMeCH₂CHMe₂

Among them, the following compounds are preferable.
Et₂CH—NH(CH₂)₂NH—CHEt₂
Et₂CH—NH(CH₂)₃NH—CHEt₂
Et₂CH—NH(CH₂)₄NH—CHEt₂
Me₂CHCH₂MeCH—NH(CH₂)₂NH(CH₂)₂NH—CHMeCH₂CHMe₂
Me₂CHCH₂MeCH—NH(CH₂)₃NH(CH₂)₃NH—CHMeCH₂CHMe₂
Me₂CHCH₂MeCH—NH(CH₂)₄NH(CH₂)₄NH—CHMeCH₂CHMe₂
Et₂CH—NH(CH₂)₂NMe(CH₂)₂NH—CHEt₂
Et₂CH—NH(CH₂)₃NMe(CH₂)₃NH—CHEt₂
Et₂CH—NH(CH₂)₄NMe(CH₂)₄NH—CHEt₂
Me₂CHCH₂MeCH—NH(CH₂)₂NMe(CH₂)₂NH—CHMeCH₂CHMe₂
Me₂CHCH₂MeCH—NH(CH₂)₃NMe(CH₂)₃NH—CHMeCH₂CHMe₂
Me₂CHCH₂MeCH—NH(CH₂)₄NMe(CH₂)₄NH—CHMeCH₂CHMe₂

Two or more of these amine compounds can be used in combination.

The structure of the amine compound is measured by ¹H-NMR and/or ¹³C-NMR analysis.

In the acid gas absorbent according to the embodiment, a ratio of water to the liquid amine compound is preferably 0.3 to 10, on a mass basis, when the liquid amine compound is 1.

In general, an acid gas absorbent having a high content rate of the amine compound has large amounts of the acid gas to be absorbed and to be desorbed per unit volume, and has a high absorption rate and desorption rate of the acid gas, and thus is preferable in terms of energy consumption, size of plant facility, and treatment efficiency.

The acid gas absorbent having a content rate of the amine compound in the above range, when used for recovering the acid gas, is advantageous in that it can effectively recover the acid gas because it has an appropriate viscosity and high amounts and rates of the acid gas to be absorbed and to be desorbed.

The acid gas absorbent according to the embodiment may contain a surfactant and/or an antifoaming agent. Content rates of them are each preferably 0.1 to 1000 ppm, and more preferably 0.1 to 100 ppm, based on a total mass of the amine compound. The content rates are each even more preferably 2 to 20 ppm. A higher content rate of the surfactant than that of the antifoaming agent provides a larger effect for improving dissipation of the amine compound. However, an excessively high content rate of the surfactant may result in excessive foamability of the acid gas absorbent and deterioration in handleability. Preferable specific examples of the antifoaming agent can include a silicone-based antifoaming agent and an organic antifoaming agent. The antifoaming agent can prevent foaming of the acid gas absorbent, suppress, for example, a decrease in absorption efficiency and desorption efficiency of the acid gas, and prevent a decrease in fluidity or circulation efficiency of the acid gas absorbent.

A viscosity when the amine compound and water absorb the acid gas to form a uniform phase is not particularly limited, but is preferably 1 to 200 mPa·s and more preferably 10 to 100 mPa·s at 25° C. The viscosity is even more preferably 40 to 60 mPa·s.

Here, the viscosity of the acid gas absorbent can be measured by VISCOMETER DV-II+Pro (trade name) manufactured by BROOKFIELD.

The acid gas absorbent according to the embodiment may contain a surfactant or an antifoaming agent as described above in addition to the liquid amine compound and water, but can contain other optional components as necessary.

In addition, examples of the optional components include an antioxidant, a pH adjusting agent, and an anticorrosive.

Preferable specific examples of the antioxidant can include dibutylhydroxytoluene (BHT), butylhydroxyanisole (BHA), sodium erythorbate, sodium nitrite, sulfur dioxide, 2-mercaptoimidazole, and 2-mercaptobenzimidazole. When the antioxidant is used, the content rate thereof is preferably 0.01 to 1 mass %, and particularly preferably 0.1 to 0.5 mass % based on the total mass of the acid gas absorbent. The antioxidant can prevent deterioration in acid gas absorbent and improve life thereof.

Preferable specific examples of the anticorrosive can include phosphoric acid esters, tolyltriazoles, and benzotriazoles. When the anticorrosive is used, the content rate thereof is preferably 0.00003 to 0.0008 mass %, and particularly preferably 0.00005 to 0.005 mass % based on the total mass of the acid gas absorbent. Such an anticorrosive can prevent corrosion of plant equipment and improve life thereof.

Preferably, the acid gas absorbent according to the embodiment does not contain an organic compound having a boiling point of 100° C. or lower. Such an organic compound may volatilize in an acid gas absorption process, causing damage to the apparatus or environmental contamination. Therefore, even when an organic compound such as an organic solvent is used for the purpose of improving solubility or the like, a content rate thereof is preferably 1 mass % or less based on the total mass of the acid gas absorbent.

In addition, the acid gas absorbent according to the embodiment preferably does not contain a metal. This is because the metal may cause damage such as corrosion to a device with which the acid gas absorbent is brought into contact. Therefore, the acid gas absorbent preferably has a metal content rate of zero. However, the acid gas absorbent may be brought into contact with a device during use, so that a metal may be eluted from the device. Therefore, inclusion of a very small amount of a metal is acceptable. However, even in such a case, a content rate of the metal is preferably 1 mass % or less based on the total mass of the acid gas absorbent.

As described above, the acid gas absorbent of the present embodiment enables absorption and recovery of the acid gas such as carbon dioxide from the gas to be treated with an excellent efficiency. Further, the regeneration treatment of the acid gas absorbent is facilitated, and less energy is required for recovering the acid gas.

The acid gas absorbent of the embodiment containing a specific liquid amine compound and water is further improved in amount of the acid gas (in particular, carbon dioxide) to be absorbed per unit mole, and amount of the acid gas to be absorbed and acid gas absorption rate per unit volume of the acid gas absorbent are further improved.

### <Method for Removing Acid Gas>

The method for removing an acid gas according to an embodiment includes bringing a gas to be treated containing an acid gas into contact with the acid gas absorbent to remove the acid gas from the gas to be treated.

The method for removing an acid gas according to the embodiment has a basic configuration including: a step of absorbing an acid gas into the acid gas absorbent according to the embodiment (first step) (absorption step); and a step of desorbing the acid gas from the acid gas absorbent according to the embodiment which has absorbed the acid gas (second step) (regeneration step).

That is, the basic configuration of the method for removing an acid gas according to the embodiment includes: a step of bringing a gas to be treated containing an acid gas (for example, an exhaust gas or the like) into contact with the acid gas absorbent to cause the acid gas absorbent to absorb the acid gas (first step); and a step of desorbing the acid gas by heating or the like of the acid gas absorbent which has absorbed the acid gas, obtained in the acid gas absorption step, to regenerate the acid gas absorbent (second step).

The method in which the gas to be treated containing the acid gas is brought into contact with the acid gas absorbent in the step (first step) is not particularly limited, and can be performed, for example, by a method in which the gas to be treated is bubbled into the acid gas absorbent, a method in which the acid gas absorbent is dropped in a mist form into a gas flow of the gas to be treated (atomizing or spraying method), a method in which the gas to be treated and the acid gas absorbent are brought into countercurrent contact with each other in an absorber containing a filler made of porcelain or metal mesh, a method of introducing the acid gas and the acid gas absorbent together into a static mixer, or the like. In any of the methods, it is preferable to stir the acid gas absorbent before or during contact, because the acid gas absorbent that has not absorbed the acid gas tends to be separated into two phases.

A temperature of the first step (absorption step) is usually preferably room temperature to 60° C. The temperature is more preferably 50° C. or lower, and particularly preferably 20 to 45° C. In general, the lower the temperature is, the more the amount of the acid gas to be absorbed increases, but a lower limit value of the treatment temperature can be determined by a gas temperature in the process, a heat recovery target, and the like. A pressure during absorption of the acid gas is usually almost atmospheric pressure. Although it is also possible to increase the pressure to a higher level in order to enhance the absorption performance, it is preferable to absorb the acid gas under atmospheric pressure in order to suppress the energy consumption required for compression.

Examples of a method for separating the acid gas such as carbon dioxide from the acid gas absorbent that has absorbed the acid gas and recovering pure or high-concentration acid gas include a method of heating the acid gas absorbent while expanding a liquid interface in a shelf tower, a spray tower, or a regeneration tower containing a filler made of porcelain or metal mesh.

In the second step (regeneration step), the amount of the acid gas to be desorbed increases as the temperature increases. For this reason, the acid gas absorbent is generally heated to about 120° C. in many cases. However, when the temperature is increased, the energy required for heating the absorbent is increased, and thus a low temperature at the time of regeneration is preferable. Since the liquid amine compound used in the acid gas absorbent according to the embodiment sufficiently releases the acid gas at a low temperature, the acid gas absorbent can be regenerated at a temperature lower than that for a general acid gas absorbent. Specifically, the acid gas absorbent can be regenerated generally at 100° C. or lower, preferably 80° C. or lower, and more preferably 70° C. or lower. In addition, a pressure during regeneration can be usually about 1 to 3 atm, but the acid gas can be efficiently released by reducing the pressure. In the second step, either heating or pressure reduction can be employed, and they can also be combined in order to improve the efficiency of the regeneration.

The acid gas absorbent after release of the acid gas can be sent to the first step (absorption step) again for circulation use (recycling). Since the acid gas absorbent from which the acid gas has been separated is separated into two phases, i.e., an amine compound phase and an aqueous phase, these phases are adjusted to achieve a predetermined composition as necessary and sent to the first step (absorption step). According to need, stirring or mixing can be performed before the first step (absorption step). Since a contact efficiency of the amine compound with the aqueous phase and the acid gas affects the acid gas absorption rate, it is necessary to efficiently contact them. In addition, in the first step (absorption step), heat generated at the time of absorption of the acid gas is generally used for a course of recycling the acid gas absorbent, that is, for heating an acid gas absorption liquid injected into a regenerator in the second step.

The purity of the thus recovered acid gas is usually as high as about 95 to 99 vol %. The pure acid gas or the high-concentration acid gas can be used as a synthetic raw material for a chemical product or a polymer substance, a cooling agent for freezing foods, or the like. In addition, it is also possible to isolate and store the recovered acid gas in the underground or the like that is now under technical development.

Among the steps described above, the second step (regeneration step) consumes the largest amount of energy, and, in the second step (regeneration step), about 50 to 80% of the energy required for all the steps may be consumed. Therefore, by reducing the energy to be consumed in the second step (regeneration step), a cost of the process for absorption and separation of the acid gas can be reduced, and the acid gas can be economically advantageously and efficiently removed from the exhaust gas.

According to the present embodiment, the use of the acid gas absorbent of the above embodiment enables separation thereof into the amine compound phase and the aqueous phase in the second step (regeneration step). In a general acid gas removal method, an acid gas absorbent composed of one phase after desorption of the acid gas is subjected to a purification treatment. On the other hand, in the acid gas removal method according to the embodiment, the heterogeneous acid gas absorbent composed of two phases can be subjected to the purification treatment collectively, but the amine compound phase and the aqueous phase can be independently purified.

The use of the acid gas absorbent causes, for example, decomposition of a compound, so that impurities are produced. Most of such impurities are water-soluble, and thus, when the acid gas absorbent is separated into two phases, most of the impurities are eluted into the aqueous phase. Therefore, the acid gas absorbent can be efficiently regenerated and purified by purifying the aqueous phase. It is also effective to replace the aqueous phase with pure water or the like as necessary.

In addition, impurities may be dissolved also in the amine compound phase, but the capacity of the amine compound phase to be purified is reduced with respect to the total amount of the acid gas absorbent, and thus the amount of the liquid to be purified is reduced, so that an energy cost required for purification can also be reduced.

As described above, the acid gas removal method according to the embodiment can reduce the energy required for the second step (regeneration step) and the subsequent purification step. Therefore, the removal and recovery of the acid gas can be efficiently performed under economically advantageous conditions.

### <Acid Gas Removal Apparatus>

The acid gas removal apparatus according to an embodiment includes:
an absorber that removes an acid gas from a gas to be treated containing the acid gas by causing the acid gas absorbent described above to absorb the acid gas by contact between the gas to be treated and the acid gas absorbent; and
a regenerator that desorbs the acid gas from the acid gas absorbent that has absorbed the acid gas to regenerate the acid gas absorbent.

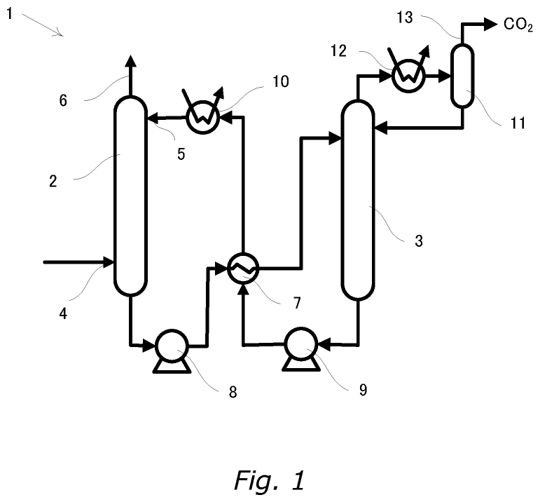

FIG. 1 is a schematic diagram of an acid gas removal apparatus according to an embodiment.

An acid gas removal apparatus 1 includes: an absorber 2 that brings a gas to be treated containing an acid gas (for example, exhaust gas) into contact with an acid gas absorbent and absorbs and removes the acid gas from the gas containing the acid gas; and a regenerator 3 that separates the acid gas from the acid gas absorbent that has absorbed the acid gas and regenerates the acid gas absorbent. Hereinafter, a case where the acid gas is carbon dioxide will be described as an example.

As illustrated in FIG. 1, an exhaust gas containing carbon dioxide such as a combustion exhaust gas discharged from a thermal power plant or the like is guided to a lower portion of the absorber 2 through a gas supply port 4. This exhaust gas is pushed into the absorber 2 and comes into contact with the acid gas absorbent supplied from an acid gas absorbent supply port 5 in an upper portion of the absorber 2. As the acid gas absorbent, the acid gas absorbent according to the embodiment described above is used.

As the acid gas absorbent, the above-described acid gas absorption liquid is used. The acid gas absorption liquid is separated into two phases in a standing state, and thus is preferably dispersed by stirring or the like prior to contact. In addition to the specific amine compound and water, the acid gas absorbent may contain other compounds such as a nitrogen-containing compound that improves a carbon dioxide absorption performance, an antioxidant, and a pH adjuster in an arbitrary ratio.

As described above, the exhaust gas comes into contact with the acid gas absorbent, so that the amine compound in the acid gas absorption liquid and the carbon dioxide in the exhaust gas react to form a salt, and the acid gas absorbent is in a uniform state from two phases. On the other hand, carbon dioxide in the exhaust gas is absorbed by the acid gas absorbent and removed. The exhaust gas from which carbon dioxide has been removed is discharged from the gas discharge port 6 to the outside of the absorber 2.

The acid gas absorbent (rich liquid) that has absorbed carbon dioxide is fed to a heat exchanger 7 by a rich liquid pump 8, and further fed to the regenerator 3. The acid gas absorbent fed into the regenerator 3 moves from an upper portion to a lower portion of the regenerator 3, and, during this time, the acid gas in the acid gas absorbent is desorbed, and the acid gas absorbent is regenerated. In a course of the acid gas desorption, an amine compound is produced from a salt of the amine compound in the acid gas absorption liquid, and is separated into an amine compound phase and an aqueous phase at a bottom of the regenerator 3.

The acid gas absorbent (lean liquid) regenerated by the regenerator 3 is fed to the heat exchanger 7 and an absorbent cooler 10 by a lean liquid pump 9, and returned from the acid gas absorbent supply port 5 to the absorber 2. In FIG. 1, the number of feeding pipes for the lean liquid is one, but the two phases, amine compound phase and aqueous phase, that have been separated in the regenerator 3 can be fed independently. It is also possible to perform a purification treatment independently for each of the phases. When the amine compound phase and the aqueous phase are independently fed from the regenerator 3, they are each subjected to a purification treatment as necessary, and then mixed at any stage until they are supplied from the acid gas absorbent 5 to the absorber 2. In mixing, a blending ratio between the amine compound phase and the aqueous phase can be adjusted to improve an acid gas absorption efficiency. In adjusting the blending ratio, it is also possible to newly add an amine compound or water. Further, in reusing the regenerated acid gas absorption liquid, it is preferable to disperse the acid gas absorbent separated into two phases by stirring or the like prior to bringing the acid gas absorption liquid into contact with the exhaust gas in the absorber 2.

On the other hand, the carbon dioxide separated from the acid gas absorbent can be discharged from an upper portion of the regenerator 3. At this time, for example, the carbon dioxide can be brought into contact with reflux water supplied from a reflux drum 11 and discharged to the outside of the regenerator 3.

The reflux water in which carbon dioxide is dissolved is cooled by a reflux condenser 12, and then separated from a liquid component in which water vapor accompanied with carbon dioxide is condensed, in the reflux drum 11. This liquid component is guided to the acid gas recovery step by a recovery acid gas line 13. On the other hand, the reflux water from which carbon dioxide has been separated is fed to the regenerator 3.

According to the acid gas removal apparatus 1 of the present embodiment, it is possible to efficiently regenerate the acid gas absorption liquid while reducing the energy required for regenerating the acid gas absorption liquid.

A method for synthesizing the liquid compound having a secondary amine structure used in the embodiment will be briefly described. The following synthesis methods are examples, and the synthesis method for the compound is not limited thereto.

A first synthesis method is a nucleophilic substitution reaction between an amine and a haloalkane. For the compound of Formula (a), X—R²—X (X is, for example, Br) is reacted with R¹NH₂ (R³NH₂), and, for the compound of Formula (b), X—R⁵—NR⁶—R⁷—X is reacted with R⁴NH₂ (R⁸NH₂), whereby desired compounds can be obtained.

A second synthesis method is a reductive amination reaction of a ketone. For the compound of Formula (a), a desired amine compound can be obtained by reducing an imine derivative obtained by reacting NH₂—R²—NH₂ with R′R″C═O. At this time, R¹ or R³ is CHR′R″. For the compound of Formula (b), NH₂—R⁵—NR⁶—R⁷—NH₂ may be used instead of NH₂—R²—NH₂. At this time, R⁴ or R⁸ is CHR′R″.

### EXAMPLES

Hereinafter, Examples of the embodiment will be described. In the following Examples, conditions before heating the acid gas absorbent were 25° C. and atmospheric pressure.

### Example 1

When a compound (a-1) of General Formula (a) wherein R¹ and R³ are 1-ethylpropyl groups and R² is C3 linear alkyl and water were blended at a mass ratio of 50:50, two phases of an organic phase (amine compound phase) as an upper phase and an aqueous phase as a lower phase were formed. As a result of bubbling a gas of CO₂:N₂=1:9, at 0.5 L/min, into 20 g of the mixture in which the two phases were formed, the mixture absorbed 12 NL/kg of carbon dioxide for 10 minutes from the start and 48 NL/kg of carbon dioxide for 100 minutes from the start. The mixture that had absorbed carbon dioxide and formed one phase was added dropwise from the top of a glass column packed with a molecular sieve 4A having a height of 36 cm and a diameter of 30 mm. The temperature in the column was changed in a range of 60° C. to 70° C., and an inert gas was caused to flow at 50 ml/min. When the mixture that had passed through the column was fractionated, two phases were formed therein. It was confirmed that the mixture released carbon dioxide and was regenerated. Here, the amount of carbon dioxide saturated and absorbed is a value obtained by measuring the amount of inorganic carbon in the acid gas absorbent with an infrared gas concentration measuring apparatus. The amount of this compound dissolved was 18,000 mg/L at 25° C. and under atmospheric pressure. The amount of the compound dissolved was determined by sampling the lower phase of the two phases fractionated, measuring the total organic carbon concentration with a total organic carbon meter TOC-L (trade name) manufactured by Shimadzu Corporation, and converting it into the amount of amine dissolved from the chemical formula of the compound (a-1).

### Comparative Example 1

When diisopropylmethylamine and water were blended at a ratio of 50:50, two phases of an organic phase (amine compound phase) as an upper phase and an aqueous phase as a lower phase were formed. As a result of bubbling a gas of CO₂:N₂=1:9, at 0.5 L/min, into 20 g of the mixture in which the two phases were formed, the mixture absorbed 3.6 NL/kg of carbon dioxide for 10 minutes from the start and 20.3 NL/kg of carbon dioxide for 100 minutes from the start.

### Example 2

When a compound (b-1) of General Formula (b) wherein R⁴ and R⁸ are 1-ethylpropyl groups, R⁵ and R⁷ are C3 linear alkyl, and R⁶ is a methyl group and water were blended at a mass ratio of 50:50, two phases of an organic phase as an upper phase and an aqueous phase as a lower phase were formed. As a result of bubbling a gas of CO₂:N₂=1:9, at 0.5 L/min, into 20 g of the mixture in which the two phases were formed, the mixture absorbed 7 NL/kg of carbon dioxide for 10 minutes from the start and 38 NL/kg of carbon dioxide for 100 minutes from the start. The mixture that had absorbed carbon dioxide and formed one phase was added dropwise from the top of a glass column packed with a molecular sieve 4A having a height of 36 cm and a diameter of 30 mm. The temperature in the column was changed in a range of 60° C. to 70° C., and an inert gas was caused to flow at 50 ml/min. When the mixture that had passed through the column was fractionated, two phases were formed therein. It was confirmed that the mixture released carbon dioxide and was regenerated. The amount of this compound dissolved was 22,000 mg/L at 25° C. and under atmospheric pressure. The dissolved amount was measured in the same manner as in Example 1.

### Example 3

When a compound (b-2) of General Formula (b) wherein R⁴ and R⁸ are 3-dimethylbutyl groups, R⁵ and R⁷ are C3 linear alkyl, and R⁶ is a methyl group and water were blended at a mass ratio of 50:50, two phases of an organic phase as an upper phase and an aqueous phase as a lower phase were formed. As a result of bubbling a gas of CO₂:N₂=1:9, at 0.5 L/min, into 20 g of the compound in which the two phases were formed, the mixture absorbed 7 NL/kg of carbon dioxide for 10 minutes from the start and 36 NL/kg of carbon dioxide for 100 minutes from the start. The mixture that had absorbed carbon dioxide and formed one phase was added dropwise from the top of a glass column packed with a molecular sieve 4A having a height of 36 cm and a diameter of 30 mm. The temperature in the column was changed in a range of 60° C. to 70° C., and an inert gas was caused to flow at 50 ml/min. When the mixture that had passed through the column was fractionated, two phases were formed therein. It was confirmed that the mixture released carbon dioxide and was regenerated. The amount of this compound dissolved was 4,000 mg/L at 25° C. and under atmospheric pressure. The dissolved amount was measured in the same manner as in Example 1.

### Example 4

When a compound (b-3) of General Formula (b) wherein R⁴ and R⁸ are 3-dimethylbutyl groups, R⁵ and R⁷ are C3 linear alkyl, and R⁶ is hydrogen and water were blended at a mass ratio of 50:50, two phases of an organic phase as an upper phase and an aqueous phase as a lower phase were formed. As a result of bubbling a gas of CO₂:N₂=1:9, at 0.5 L/min, into 20 g of the mixture in which the two phases were formed, the mixture absorbed 11 NL/kg of carbon dioxide for 10 minutes from the start and 56 NL/kg of carbon dioxide for 100 minutes from the start. The mixture that had absorbed carbon dioxide and formed one phase was added dropwise from the top of a glass column packed with a molecular sieve 4A having a height of 36 cm and a diameter of 30 mm. The temperature in the column was changed in a range of 60° C. to 70° C., and an inert gas was caused to flow at 50 ml/min. When the mixture that had passed through the column was fractionated, two phases were formed therein. It was confirmed that the mixture released carbon dioxide and was regenerated. The amount of this compound dissolved was 11,000 mg/L at 25° C. and under atmospheric pressure. The dissolved amount was measured in the same manner as in Example 1.

### Reference Examples 1 and 2

When the compound (a-1) and water were blended at a volume ratio of 50:50, two phases of an organic phase as an upper phase and an aqueous phase as a lower phase were formed. One (1) ml of 1 mol/1 sulfuric acid was added to 30 ml of the mixture, and, after stirring, the S concentration of the aqueous phase was measured by ICP. As a result, the S concentration was 17.6 mg-S/L (Reference Example 1). When sulfuric acid was added to water not containing the compound (a-1) in the same manner as in Reference Example 1, the S concentration was 9.8 mg-S/L. These results showed that water-soluble impurities were present in a biased manner in the aqueous phase.

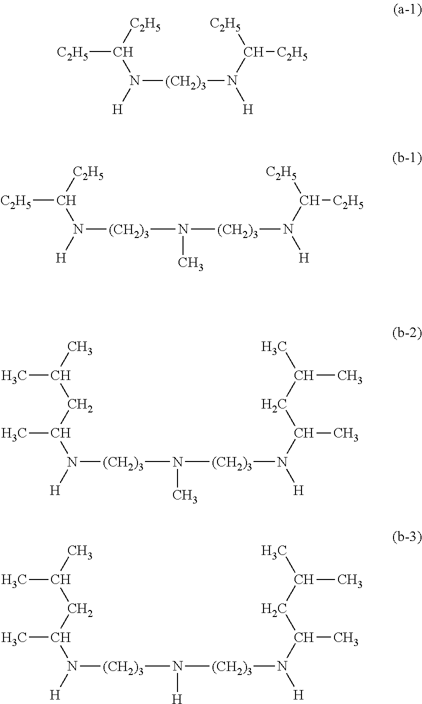

From the results of the respective examples, it was confirmed that the mixtures containing a specific amine compound and water and forming two phases before absorption of the acid gas absorb the acid gas and form one phase. As a result of adding sulfuric acid to the mixture forming two phases, the sulfuric acid component was detected from the aqueous phase. Therefore, an acid gas absorbent which contains a specific amine compound and is separated from water into two phases when carbon dioxide is not contained in the system is easily separated from water-soluble impurities contained in the system and is easily regenerated and purified, and thus has a long life as an absorbent. Therefore, the acid gas absorbent can reduce the amine compound to be discarded, and, even in the case of being recycled, is regenerated from a state of being separated from water, and thus can be regenerated with low energy.

The acid gas absorbent, the acid gas removal method, and the acid gas removal apparatus according to at least one embodiment described above can realize an acid gas absorption system with less waste and reduced energy required for regeneration.

As described above, some embodiments have been described, but these embodiments have been presented as examples, and are not intended to limit the scope of the invention. These novel embodiments can be implemented in various other forms, and various combinations, omissions, substitutions, changes, and the like can be made without departing from the gist of the invention. These embodiments and variations thereof are included in the scope and gist of the invention, and are included in the invention according to the claims and the equivalent thereof.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the invention.

1. An acid gas removal method for removing an acid gas from a gas to be treated containing the acid gas, the method comprising:
a first step of bringing the gas to be treated into contact with an acid gas absorbent to absorb the acid gas; and
a second step of releasing a part of the acid gas from the acid gas absorbent that has absorbed the acid gas in the first step to regenerate the acid gas absorbent, wherein
the acid gas absorbent is a mixture containing a liquid amine compound having a secondary amine structure and water, and
an amount of a salt to be dissolved in water is larger than an amount of the liquid amine compound to be dissolved in water, the salt being formed from the liquid amine compound and the acid gas.

2. The acid gas removal method according to claim 1, wherein the acid gas absorbent is brought into a state of being phase-separated into an organic phase and an aqueous phase after the part of the acid gas is released in the second step.

3. The acid gas removal method according to claim 1, wherein an amount of the liquid amine compound to be dissolved in water at 25° C. is 50,000 mg/L or less.

4. The acid gas removal method according to claim 1, wherein
the liquid amine compound is represented by the following formula (a) or (b): 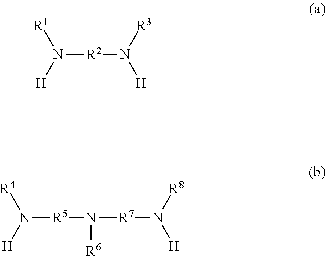
wherein:
R¹, R³, R⁴, and R⁸ are each independently a linear alkyl group, a branched alkyl group, a cyclic alkyl group, a heterocyclic aliphatic group containing oxygen or sulfur, a substituted or unsubstituted aliphatic group composed of three elements of carbon, nitrogen, and hydrogen atoms, or a substituted or unsubstituted aromatic group,
R², R⁵, and R⁷ are each independently a C1 to C7 linear alkylene chain or a C3 to C7 branched alkylene chain, and
R⁶ is a linear alkyl group, a branched alkyl group, a substituted or unsubstituted aliphatic group composed of three elements of carbon, nitrogen and hydrogen atoms, a substituted or unsubstituted aromatic group, or hydrogen.

5. The acid gas removal method according to claim 4, wherein
R¹, R³, R⁴, and R⁸ are each independently a linear or branched C3 to C6 alkyl group,
R², R⁵, and R⁷ are each independently a C2 to C4 linear alkylene chain or a C3 to C4 branched alkylene chain, and
R⁶ is a linear or branched C1 to C3 alkyl group, or hydrogen.

6. The acid gas removal method according to claim 4, wherein
R¹ and R³ are identical, and
R⁴ and R⁸ are identical.

7. The acid gas removal method according to claim 1, wherein, in the second step, the acid gas that has been released is recovered.

8. The acid gas removal method according to claim 1, wherein the acid gas absorbent regenerated in the second step is reused in the first step.

9. The acid gas removal method according to claim 1, further comprising a step of stirring and mixing an acid gas absorbent in advance before the first step.

10. The acid gas removal method according to claim 1, wherein the gas to be treated, from which the acid gas is removed in the first step, is released into an environment after at least a part thereof is removed by the liquid amine compound.

11. The acid gas removal method according to claim 1, wherein the second step is intended to regenerate the acid gas absorbent by heating and/or pressure reduction.

12. The acid gas removal method according to claim 1, wherein, in the second step, the acid gas absorbent is heated using heat generated in the first step to regenerate the acid gas absorbent.

13. The acid gas removal method according to claim 1, wherein the acid gas is carbon dioxide.

14. An acid gas remover comprising a mixture of a liquid amine compound having a secondary amine structure and water, wherein
an amount of a salt to be dissolved in water is larger than an amount of the liquid amine compound to be dissolved in water, the salt being formed from the liquid amine compound and an acid gas.

15. The acid gas remover according to claim 14, which is in a state of being phase-separated into an organic phase and an aqueous phase before contact with the acid gas.

16. An acid gas removal apparatus comprising:
an absorber that removes an acid gas from a gas to be treated containing the acid gas by causing the acid gas absorbent according to claim 14 to absorb the acid gas by contact between the gas to be treated and the acid gas absorbent; and
a regenerator that desorbs the acid gas from the acid gas absorbent that has absorbed the acid gas to regenerate the acid gas absorbent.
